(19) United States
(12) Patent Application Publication
(10) Pub. No.: US 2005/0277321 A1
(43) Pub. Date: Dec. 15, 2005

(54) Adapter apparatus for fluorescent lamp fixtures

(76) Inventor: Suresh Shah, Thane (IN)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 11/093,291

(22) Filed: Mar. 30, 2005

Related U.S. Application Data
(60) Provisional application No. 60/557,421, filed on Mar. 30, 2004.

(51) Int. Cl. H01R 33/08

(52) U.S. Cl. 439/236

(57) ABSTRACT

An adapter assembly for converting a fluorescent lamp fixture to accept lamps of a different size than the fixture is configured to accommodate. The assembly comprises two adapters in combination with a support rod. The adapters are located at the respective ends of the support rod and plug into the sockets of the fixture. The adapters comprise sockets slideably disposed on a tongue portion for adjustment of the vertical position of the new fluorescent lamp.

This application claims priority from a provisional application, Ser. No. 60/557,421, filed Mar. 30, 2004.

### FIELD OF THE INVENTION

The present invention is directed to the field of fluorescent lighting fixtures, and in particular to apparatus for mounting lamp tubes in such fixtures.

### BACKGROUND OF THE INVENTION

In the effort to reduce the power consumption of fluorescent lamps used in room lighting, modem electronic techniques have been applied to reduce not only the power consumption, but also the size of fluorescent lamp tubes. This has been accomplished without a sacrifice in the luminosity of the smaller lamps. Thus a smaller fluorescent lamp tube can produce a comparable amount of light on a one-for-one basis as did older, larger lamp tubes and do so while consuming less electrical power than the older tubes.

Individuals and facility managers wishing to take advantage of the economies offered by the new lamp tubes, however, face a decision. The new lamp tubes are smaller in at least two dimensions, length and diameter, than their predecessors. Unless there is a way to fit the new size lamp tubes in the existing fixtures, not only would individuals and facility managers have to replace old lamp tubes with new ones, but also replace the old fixtures at the same time. That can present an expense that discourages the prospective users from making the change at all.

Thus, there is a need for adaptive hardware to allow the new dimension lamp tubes to be fitted into old lamp fixtures. The present invention is an example of one such adaptive apparatus.

### SUMMARY OF THE INVENTION

An adapter assembly for converting a light fixture having fluorescent lamp sockets from one size fluorescent lamp to another comprising a pair of adapters connected to a support rod with first and second ends. The adapters are located at the respective ends of said support rod. Each of the adapters comprises a main body to which the support rod is connected, and further comprises connecting pins for connection to the light fixture sockets. The adapters each further comprise a tongue portion whereon is disposed a socket for mounting a fluorescent lamp.

### BRIEF DESCRIPTION OF THE DRAWINGS

For the purpose of illustrating the invention, there are shown in the drawings forms which are presently preferred; it being understood, however, that this invention is not limited to the precise arrangements and instrumentalities shown.

FIG. 1 is a depiction of the adapter connected to the support rod and having a fluorescent lamp mounted in the adapter.

FIG. 2a is a perspective view of one embodiment of the adapter.

FIG. 2b is a partial perspective view of a second embodiment of the adapter.

### DETAILED DESCRIPTION OF THE INVENTION

For the purpose of adapting a smaller, shorter tube into a fixture that was designed to accommodate a larger, longer tube, the invention is an adapter and support apparatus into which the shorter tube may be mounted. The adapter passes the electrical connections from the standard mounting sockets in the fixture through into the adapter.

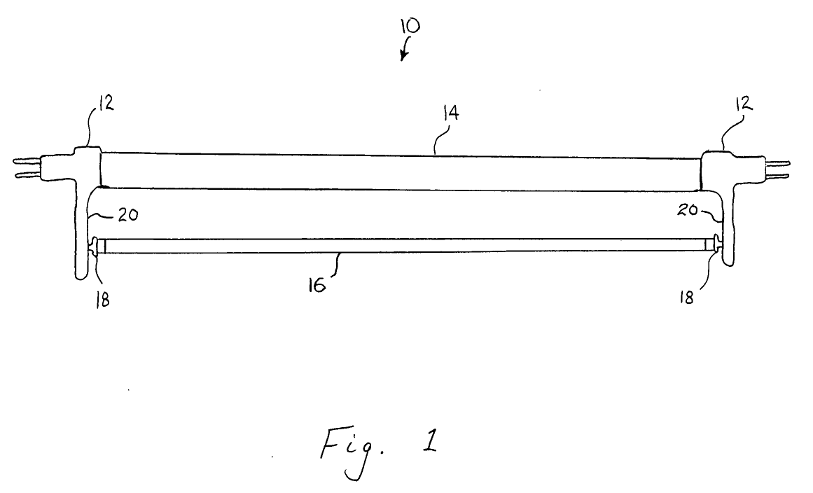

Referring to FIG. 1, the illustration shows the complete adapter assembly 10. The assembly comprises two lamp adapters 12, one at each end of the assembly. The adapters 12 are connected to each other by a support rod 14. Finally, a lamp tube 16 is shown mounted in the adapters 12. For the purpose of this description, reference to the conversion from a larger lamp fixture to the smaller lamp tube using the adapter assembly will be made as follows: the larger lamp fixture will be assumed to be a T-12 fluorescent lamp fixture and the smaller will be assumed to be a T-5 fluorescent lamp tube. Persons skilled in the art will recognize that other conversions are possible.

The adapters 12 are mounted on each end of the support rod 14. The support rod 14 provides a stable mechanical mount for the adapter 12 at the rod ends and for the lamp tube 16 that connects into the adapters 12. The electrical contact pins (not shown) on the lamp tube 16 engage a socket 18 on the adapters 12. This socket 18 is movable up and down along the inwardly facing tongue 20 of the adapter 12 so that the distance of the lamp tube 16 from the support rod 14 may be adjusted as necessary.

The support rod 14, in some applications, may contain the electronic ballast (not shown) that provides the energizing electronic signal that makes the fluorescent tube turn on and emit light. The ballast may also be a dimmable ballast that permits control of the luminosity of the fluorescent lamp mounted in the fixture.

The support rod 14 joins to the adapters 12 at the respective ends of the rod. The support rod 14 of the apparatus may provide an aperture at each end into which a protrusion on the adapter 12, shaped to fit the aperture, may be inserted for frictional engagement of the adapter to the end of the support rod. Alternatively, the protrusion may be at the ends of the rod and fit into an aperture in the adapter. Once engaged at each end of the support rod 14, two adapters 12 may support a fluorescent tube between them 16.

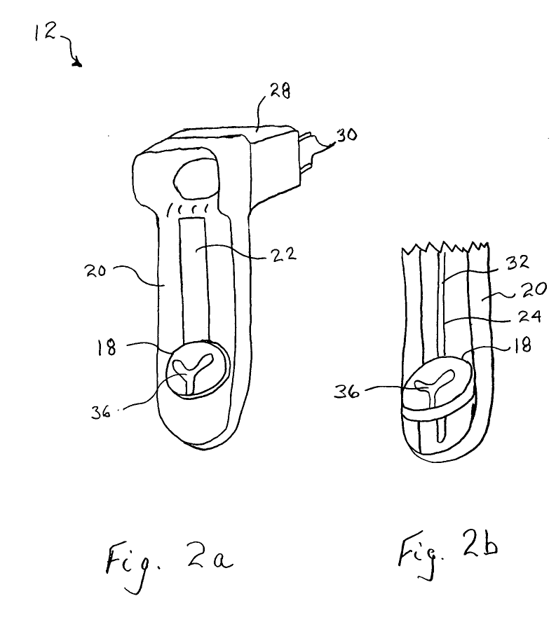

FIG. 2a shows an exemplary embodiment of the adapter 12. The adapter comprises a main body 28. On the outside of the main body 28 are the connecting pins 30 for connection to the original lighting fixture for the larger lamp that is being replaced. Each adapter 12 plugs into the old receptacles in the fixture and is supported within the fixture from the connection of the pins 30 on each adapter to the receptacles in the fixture. The connecting pins may extend from a rotatable base (not shown) in the socket body 28 so that the pins can be rotated into the proper position and locked in the fixture while maintaining the vertical orientation of the adapter 12. The main body 28 is also adapted to be joined to the support rod 14 in one of the ways described above (mating protrusions and apertures on the rod 14 and the adapter main body 28), or in another manner that suitably joins the rod and adapter in a firm connection.

The adapter further comprises a tongue portion 20 the descends from the main body 28. A socket 18 is slideably disposed either on or within the tongue portion 20. FIG. 2a shows the socket 18 disposed on the tongue portion, mounted in a vertical slot 22 that permits the socket to be moved up or down as necessary to accommodate the fixture. FIG. 2b shows the socket 18 disposed within the tongue portion, slideable up and down in the tongue portion. In this configuration, one or more small guide pins (not shown) on the rear of the socket travel in a vertical slot 32 on the outward side of the adapter 12 and prevent the socket from rotating. The socket 18 may be locked in place along the tongue slot by any one of a number of common means, such as friction locks, snaps, pins, screws and the like.

The socket 18 is configured with the appropriate grooves 36 for entry of the connecting pins at the ends of the fluorescent lamp tube 16. The socket has provision for accepting and locking into the socket the two connecting pins on a fluorescent lamp that is common to most fluorescent sockets known to those skilled in the art.

Electrical power is supplied to the fluorescent lamp tube 16 in one of at least two ways. If the ballast in the old fixture is electrically compatible with the new lamp tubes, then one configuration of the adapter routes the electrical power from the mounting pins 30 on the adapter, through the tongue portion 20, and into the socket 18 into which the new lamp is mounted. Alternatively, a new ballast may be required. That ballast may be disposed within the support rod 14. If so, its power output can be routed through the support rod and into the adapters 12 to the sockets 18.

In use, two adapters 12 are assembled with a support rod 14. The adapters 12 are plugged into the light fixture sockets and preferably locked such that the adapter tongue portions 20 extend vertically downward from the support rod 14. A new fluorescent lamp tube 16 is then mounted in the sockets 18 that are slideably adjustable on the adapter tongues. In this manner, an old light fixture originally configured for a T-12 lamp tube can be converted to accommodate a new T-5 lamp tube. The facility need not suffer the cost of replacing the old light fixtures to take advantage of the economies associated with the conversion to the more efficient lamps.

The present invention may be embodied in other specific forms without departing from the spirit or essential attributes thereof and, accordingly, reference should be made to the appended claims, rather than to the foregoing specification, as indicating the scope of the invention.

1. An adapter assembly for converting a light fixture having fluorescent lamp sockets from one size fluorescent lamp to another comprising:
a pair of adapters connected to a support rod with first and second ends, said adapters being located at the respective ends of said support rod;
each of the adapters comprising a main body to which the support rod is connected, and further comprising connecting pins for connection to the light fixture sockets;
said adapters each further comprising a tongue portion whereon is disposed a socket for mounting a fluorescent lamp.

2. The adapter assembly of claim 1, wherein the socket disposed on the tongue portion is slideably engaged with the tongue portion to permit the socket to be located as necessary.

3. The adapter assembly of claim 1, wherein the socket is disposed within the tongue portion, said socket having one or more guide pins extending into a slot in the tongue portion.

4. The adapter assembly of claim 1, wherein a ballast is contained within the support rod.

5. The adapter assembly of claim 4, wherein said ballast is a dimming ballast.

6. The adapter assembly of claim 1, wherein electrical power to energize a fluorescent lamp mounted in the adapters is provided through the connecting pins on the adapter that are connected to the fixture.

7. An adapter assembly for converting a light fixture having fluorescent lamp sockets from one size fluorescent lamp to another comprising:
an adapter comprising a main body, and further comprising connecting pins for connection to the light fixture sockets;
said adapter further comprising a tongue portion whereon is disposed a socket for mounting a fluorescent lamp, said socket being slideably engaged with the tongue portion to permit the socket to be located where necessary along the tongue portion.

8. The adapter assembly of claim 7, wherein the socket is disposed within the tongue portion, said socket having one or more guide pins extending into a slot in the tongue portion.
